(19) United States
(12) Patent Application Publication
(10) Pub. No.: US 2014/0019228 A1
(43) Pub. Date: Jan. 16, 2014

(54) System and Method for Performing Application-Level Analytics and Testing to Tailor Actions and Communications to a User's Experience

(71) Applicant: Char Software, Inc. d/b/a Localytics, Cambridge, MA (US)

(72) Inventors: Rajeev AGGARWAL, Boston, MA (US); Mohit DILAWARI, Somerville, MA (US); Henry John CIPOLLA, Weston, MA (US); Brian J. SUTHOFF, Boston, MA (US); Adam Clinton BUGGIA, Cambridge, MA (US); Randal Edward DAILY, Cambridge, MA (US)

(21) Appl. No.: 13/940,226

(22) Filed: Jul. 11, 2013

Related U.S. Application Data
(60) Provisional application No. 61/670,261, filed on Jul. 11, 2012.
(60) Provisional application No. 61/787,369, filed on Mar. 15, 2013.

(51) Int. Cl. G06Q 30/02

(52) U.S. Cl. CPC G06Q 30/0244
USPC 705/14.43

(57) ABSTRACT

A system and method for performing application-level analytics and testing to tailor actions and communications to a user's experience is disclosed. The system includes a mobile device running an application, a rules engine integrated into the application, an analytics database, a rules engine, a campaign optimization module, and a test module. The rules engine monitors a user's interaction with the application, performs specified client actions when necessary, records data on the user's interaction, and sends that data to the analytics database. Both the rules engine and the campaign optimization module then utilize the data in the analytics database to improve the performance of client actions and campaigns. Test module gives a client the ability to test a new or modified campaign within an existing version of an application on a select group of devices.

### CROSS-REFERENCE TO RELATED APPLICATIONS

This application claims priority under 35 U.S.C. §119(e) to U.S. Provisional Application Ser. No. 61/670,261 filed on Jul. 11, 2012 and 61/787,369 filed on Mar. 15, 2013, both of which are hereby incorporated by reference herein in their entirety.

### BACKGROUND

1. Field of the Disclosure

The present disclosure relates to an application-level analytics platform that tests and tailors actions and communications of an application to a user's experience.

2. Description of Related Art

Currently, companies utilize various forms of analytics to monitor usage of their websites. These website analytics are typically gathered at the server level, and provide information on the demographics and usage of a particular website. This data is used today to better understand their usage as well as execute marketing campaigns which message users and even personalize their experience on the website.

While websites are still a good source for accessing information, applications are now the primary method for phone and tablet users to extend the functionality of their devices and access content and services. However, existing website analytics programs cannot translate all of their functionalities to applications (apps) for several reasons. First, apps, unlike websites, have the ability to function without network access. This requires policies and actions in the app to execute on the client device without constant access to network or server resources. Second, mobile apps run in an environment native to the platform unlike on the web where all pages execute via HTML and Javascript. As a result, any changes to the user experience require integration with the code running in the app. Lastly, apps in modern operating systems are “sandboxed” or separated from other apps and many device resources. This requires that in-app actions and messages be managed and delivered within the application for a controlled user experience.

What is needed is an analytics and advertising platform that can obtain user behavior and demographic data from apps, along with other sources, and use that data to execute marketing campaigns within the app and through other channels.

### SUMMARY OF THE INVENTION

A system and method for performing application-level analytics and testing to tailor actions and communications to a user's experience. The system includes a mobile device running an application, a device policy engine integrated into the application, an analytics database, a rules engine, a campaign optimization module, and a test module. The device policy engine includes a list of campaigns comprising a plurality of trigger events and their corresponding client actions. The device policy engine monitors the user's interactions with the application, determines if a trigger event has occurred, performs a client action corresponding to the trigger event that has occurred, and records data relating to the user's interactions with the campaign. The analytics database receives the recorded data from the device policy engine, as well as additional information on new or modified campaigns from a client. The rules engine receives parameters of the campaigns and augments them with data from the analytics database to come up with a set of rules for at least one campaign that is sent to the device policy engine. The campaign optimization module also draws on data from the analytics database to improve the performance of at least one campaign. Lastly, the test module generates test campaigns based on information it has received on new or modified campaigns, and sends those test campaigns to a specified group of users. The test module also provides the client with a control panel to manage, test, and change the campaign as needed.

Further, the system of the present disclosure is configured to perform client actions such as in-app messaging, in-app redirection, application configuration changes, and application modification.

Yet further, the system of the present disclosure is configured to allow a client to build a new message and select at least one of: a targeted audience, a targeted device, various message characteristics, and a trigger for initiating the message.

The system of the present disclosure is also configured to have the rules engine continuously query analytics database for data that could change the set of rules for at least one campaign. If the rules engine determines that a modification of rules is needed for at least one campaign, it can then generate an updated set of rules and transmit them to the device policy engine.

Further, the system of the present disclosure includes a campaign interface that is configured to allow a client to build a new campaign and provide a client with real-time analytics data on the campaign.

Yet further, the system of the present disclosure is configured so that the campaign optimization module can automatically make changes to at least one of the optimization rules for a campaign to increase its performance.

The system of the present disclosure is also configured to allow test users to use the test campaign in existing versions of the application.

Further, the system of the present disclosure is configured to allow the device policy engine to continue operating regardless of whether the mobile device has a network connection.

### BRIEF DESCRIPTION OF THE DRAWINGS

The present disclosure will further be described by way of example and with reference to the following drawings, in which:

FIG. 1 shows an illustrative system diagram of the application-level analytics platform according to an embodiment of the present invention.

FIG. 2 shows an illustrative system diagram of the client-side of the application-level analytics platform according to an embodiment of the present invention.

FIG. 3 shows another illustrative system diagram of the SDK on an end-user's device in accordance with an embodiment of the present disclosure.

FIGS. 4A and 4B show illustrative front views of in-app messages according to an embodiment of the present disclosure.

FIGS. 5-11 show illustrative front views of the user-interface for building an in-app message according to several embodiments of the present disclosure.

FIG. 12 shows an illustrative front view of the preview feature after an in-app message has been built, in accordance with an embodiment of the present disclosure.

FIG. 13 shows exemplary flow diagrams of application configuration changes in accordance with several embodiments of the present disclosure.

FIG. 14 shows an illustrative system diagram of the databases in accordance with an embodiment of the invention.

FIG. 15 shows an illustrative system diagram of the server-side after a campaign is created or edited according to an embodiment of the present disclosure.

FIGS. 16-18 show illustrative front views of the campaign-interface for creating a new campaign in accordance with several embodiments of the present disclosure.

FIG. 19 shows an illustrative schematic of the test mode process according to an embodiment of the present disclosure.

FIGS. 20-22 show illustrative front views of the test-mode screens in accordance with several embodiments of the present disclosure.

FIG. 23 shows an illustrative front view of the campaign overview feature in the campaign interface in accordance with an embodiment of the present disclosure.

FIGS. 24-28 show illustrative front views of exemplary analytics data provided by the campaign interface in accordance with several embodiments of the present disclosure.

FIG. 29 shows an illustrative front view of the campaign optimization feature provided by the campaign interface in accordance with an embodiment of the present disclosure.

### DETAILED DESCRIPTION

The present disclosure is directed to a system and method for performing application-level analytics and testing to tailor actions and communications to a user's experience. Analytics are used in mobile applications to generate data about user activities and preferences. User data can be sorted, organized and displayed in a variety of formats. For example, user data can be selectively displayed in a computer application as raw data or in the form of charts and graphs. User data can also be filtered by various categories, such as usage, engagements, events, screens, funnels, maps, mobile devices, user's location, operating systems, user status as a new or returning customer, etc.

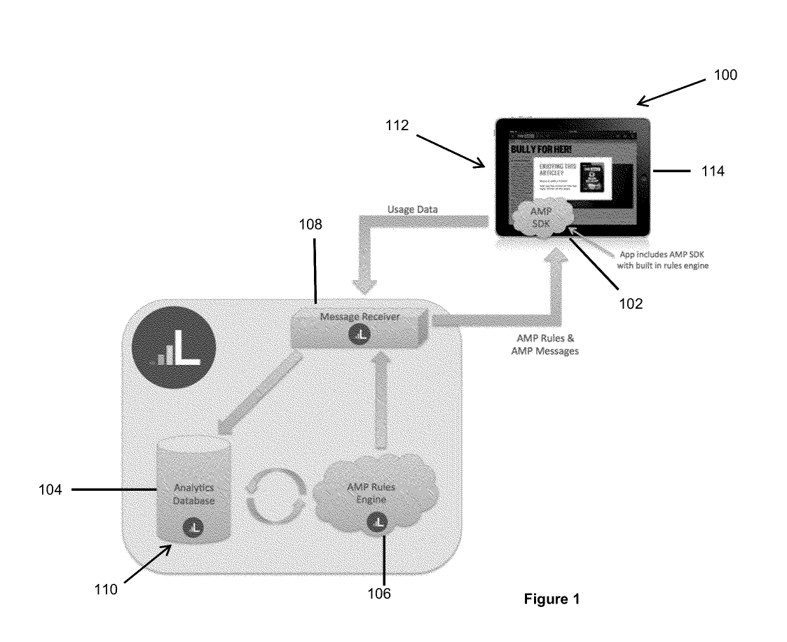

FIG. 1 shows an illustrative system diagram of application-level analytics platform 100 according to some embodiments of the disclosure. In one embodiment, the application-level analytics platform 100 includes software developer kit (SDK) 102, analytics database 104, rules engine 106, and message receiver 108. SDK 102 is on client side 112 while analytics database 104, rules engine 106, and message receiver 108 are on server side 110.

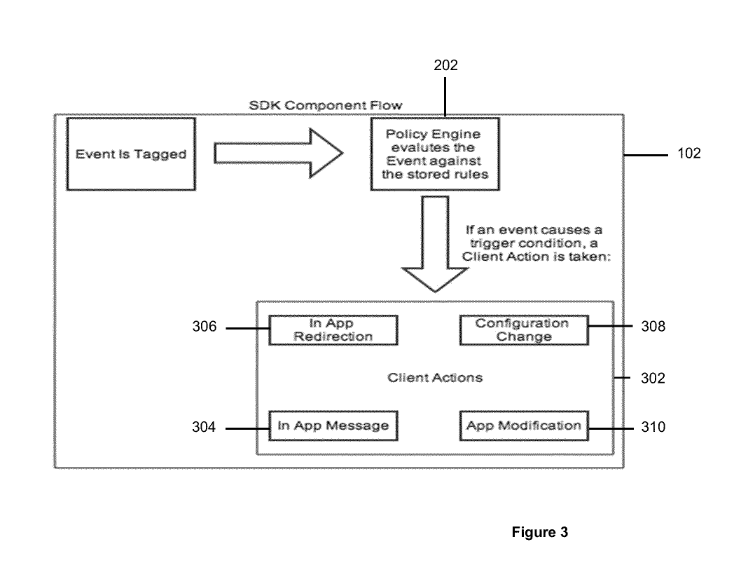

In an embodiment of the disclosure, SDK 102 is integrated into an application and is subsequently downloaded with the application onto an end user's mobile device 114. From there, SDK 102 can collect data from the user's interactions within the application, perform a particular client action 302 (FIG. 3) to enhance the user's experience, and send subsequent analytics data based on the user's experience to message receiver 108 on server side 110. Message receiver 108 can then forward that data to analytics database 104, where it is stored into various applicable storage tables (e.g., user profiles, aggregated usage data, etc.) for later use. Based on the analytics data stored in analytics database 104, as well as any client-specified rules, rules engine 106 can develop new rules and client actions 302 that can be sent to SDK 102 in the future in order to further enhance the user's experience. This architecture allows analytics platform 100 to utilize analytics to create and manage successful marketing programs, or campaigns, which define the users that are able to receive actions, the assets to be used, and the schedule for providing these actions and utilizing these assets.

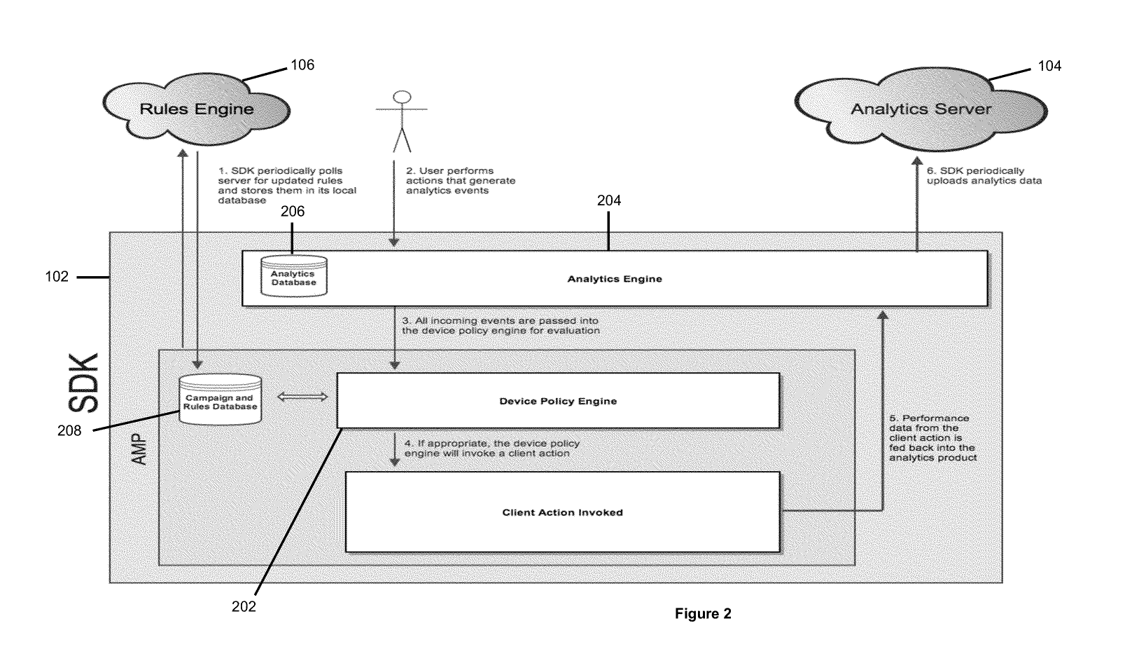

FIG. 2 shows a diagram of the communications between rules engine 106, SDK 102, and analytics database 104 according to an embodiment of the disclosure. Referring to FIG. 2, SDK 102 includes at least device policy engine 202, which is responsible for evaluating incoming actions from the user's interactions with the application, measuring those actions, and executing the appropriate corresponding client actions 302 on end-user's device 114 based on a set of rules transmitted from rules engine 106. When the application is first initiated, device policy engine 202 downloads a manifest from rules engine 106. The manifest describes every client action 302 to be performed by the application, as well as a definition of when to perform each client action 302. The device policy engine 202 can also periodically upload the manifest by downloading additional client actions 302 from rules engine 106 when the application is connected to the server. One download may contain one client action 302 or multiple client actions 302. In one embodiment, the rules and client actions 302 can be downloaded to a dedicated campaign and rules database 208 within SDK 102. In other embodiment, the rules and client actions 302 are simply downloaded to device policy engine 202.

Once device policy engine 202 has a list of client actions 302 and rules, it then monitors the user's interactions with the application and measures the significance of them in order to determine if any of the rules have been satisfied. If any of the rules of been satisfied, then device policy engine 202 performs the appropriate client action 302 associated with that rule. In one embodiment, device policy engine 202 monitors and stores all of the user's interactions with the application. In another embodiment, the user's interactions are monitoring by analytics engine 204 and stored in analytics database 206 on end-user's device 114.

Once device policy engine 202 performs a client action 302, it can then send data, such as the client action 302 and the user's interaction with the client action 302, to analytics database 104 on server-side 110. In another embodiment, device policy engine 202 can send this data to analytics database 104 via analytics engine 204.

Because device policy engine 202 runs on end-user's device 114 and maintains a list of client actions 302 locally on device 114, device policy engine 202 can perform client actions 302 in response to trigger events, even if the application does not have network connectivity. If the user loses or does not have an active internet connection after a client action 302 has been performed, SDK 102 can suspend its normal upload of analytics data surrounding the client action 302 to analytics database 104 until the user obtains an active internet connection.

In one embodiment of the present invention, exemplary triggering events that are monitored by device policy engine 202 could include: waiting some period of time after an event; the occurrence of a specific event; waiting until a specific event has occurred a certain number of times; if the user does not trigger a specific event in a given period of time; waiting until after a certain number of sessions after the user's current session; and if the user fails to complete several specific events in a given order. In another example, device policy engine 202 can be configured so that trigger events, or a subset of trigger events, have expiration dates so that the corresponding client actions 302 do not occur outside of a specified time window. In yet another example, device policy engine 202 might utilize versioning to avoid performing client actions 302 on devices 114 that do not support the corresponding client actions 302.

In response to the trigger events, device policy engine 202 can perform a variety of different client actions 302 based on rules sent by rules engine 106. As shown in FIG. 3, exemplary client actions 302 can include in-app messaging 304, in-app redirection 306, configuration change 308, and app modification 310.

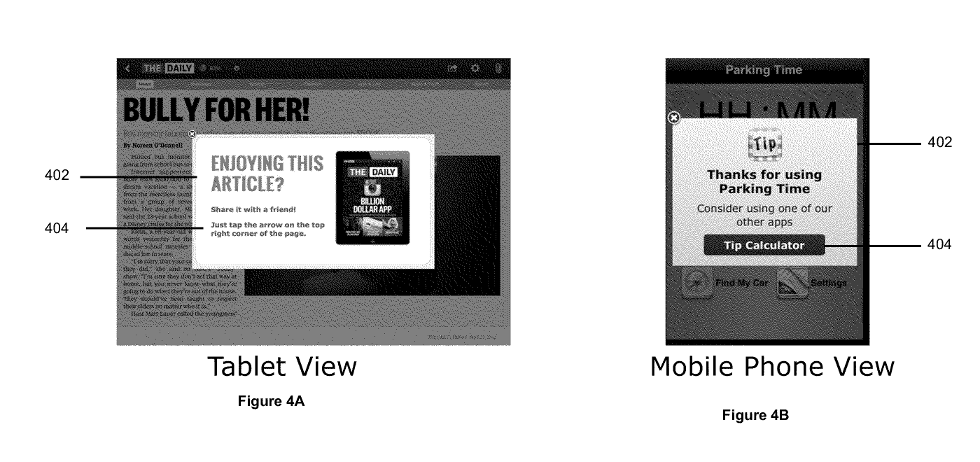

In an embodiment of the present invention, in-app messaging 304 allows a client to provide one or more messages to an end-user. In one example, in-app messages appear inside the application so that the end-user does not need to launch a web browser or otherwise leave the application to view the message. For example, as shown in FIGS. 4A-4B, in-app message 402 appears inside a skinnable webview inside the application so that a user's experience is not interrupted. In yet another embodiment of the present invention, the content of in-app message 402 can be dynamically changed at any time and re-sent to device policy engine 202. In another embodiment of the present invention, the content of in-app message 402 can include dynamic variables that can be substituted with actual values for each message 402. For example, a user's name and the last item that the user put in the shopping cart may be inserted into message 402.

In another embodiment of the present invention, in-app messages 402 can interact with the end-user. For example, in-app message 402 could include interactive content 404, such as buttons, survey content, or links to other areas of the application. In yet another embodiment, device policy engine 202 can inject javascript into the interactive content to allow in-app message 402 to be tracked by the same analytics program on device 114 that tracks the user's interactions with the rest of the application. This analytics tracking can allow a client compare to compare the effectiveness of different messaging campaigns.

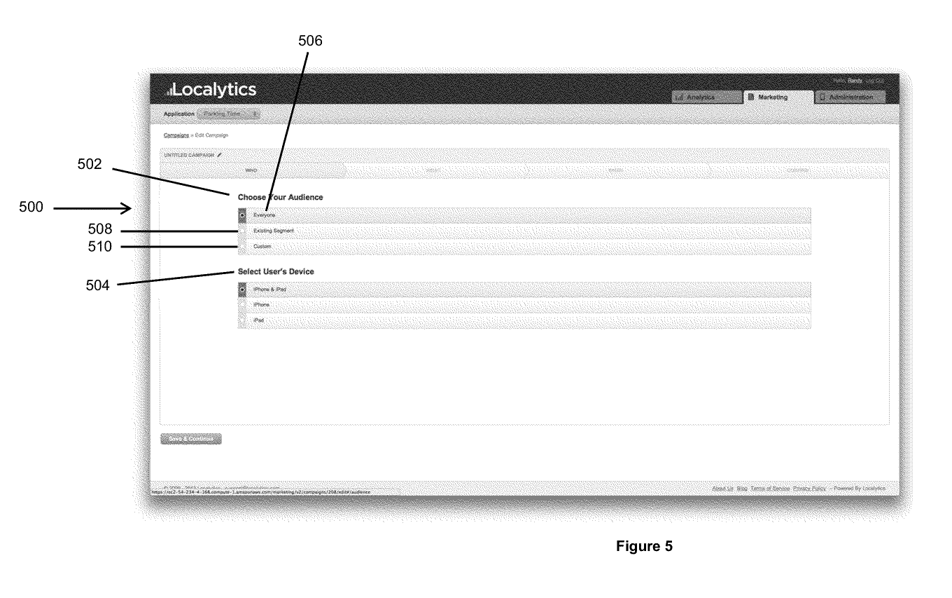

In another embodiment of the present invention, in-app messaging 304 includes a creation function to allow a client to customize in-app messages being sent to the end-user. FIGS. 5-12 illustrate exemplary stages of in-app message creation in accordance with embodiments of the present invention.

Referring to FIG. 5, user-interface 500 allows a client to first specify the target audience 502 and targeted devices 504 that will receive the message. Target audience 502 could include all users 506, an existing segment of users 508, or a customized segment of users 510.

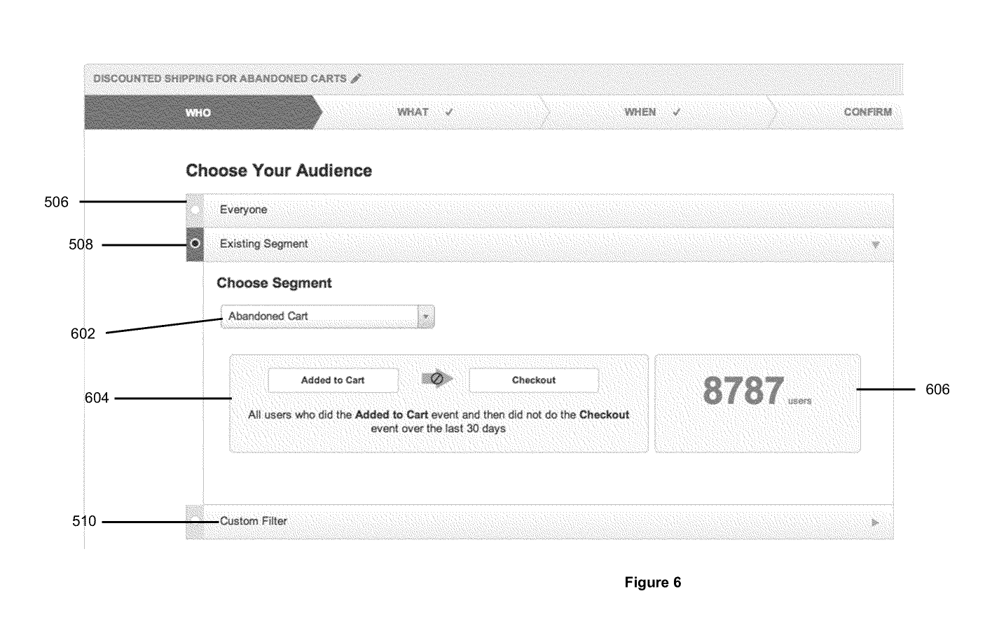

Referring to FIG. 6, if a client chooses to target the existing segment of users 508, then the client is presented with existing segments 602 to choose from. Each existing segment 602 can include the rules for targeting users 604 and the number of users in the segment 606.

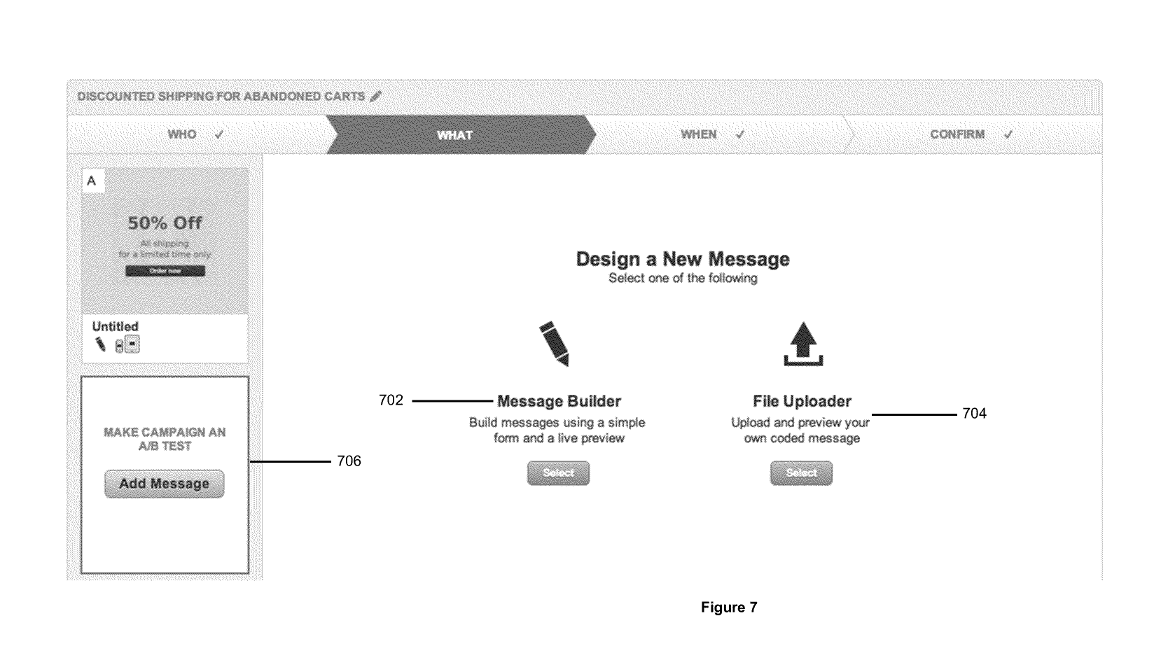

Referring to FIG. 7, a client can then choose whether to build the message 702 or upload content for the message 704.

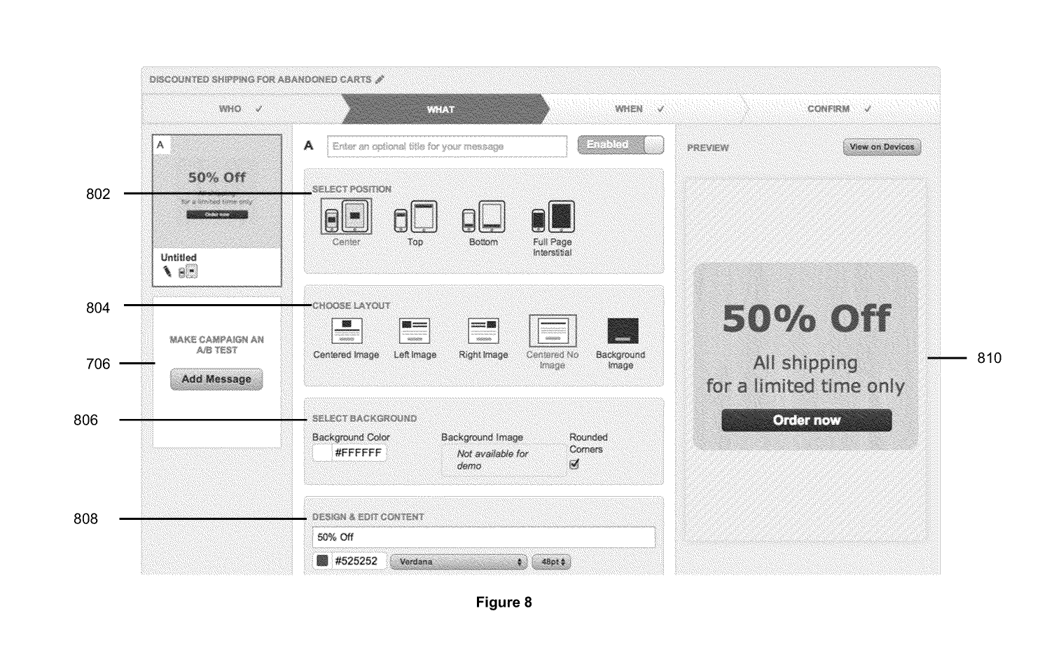

FIG. 8 illustrates the online building feature 702 in more details. In an embodiment of the present invention, online builder 702 may control several aspects of the message to be displayed, such as: the positioning of the message on the device 802, the layout of the message 804, the background colors and images 806, and the text and content of the message 808. In another embodiment, a client can constantly preview the message's appearance throughout the building process in preview window 810.

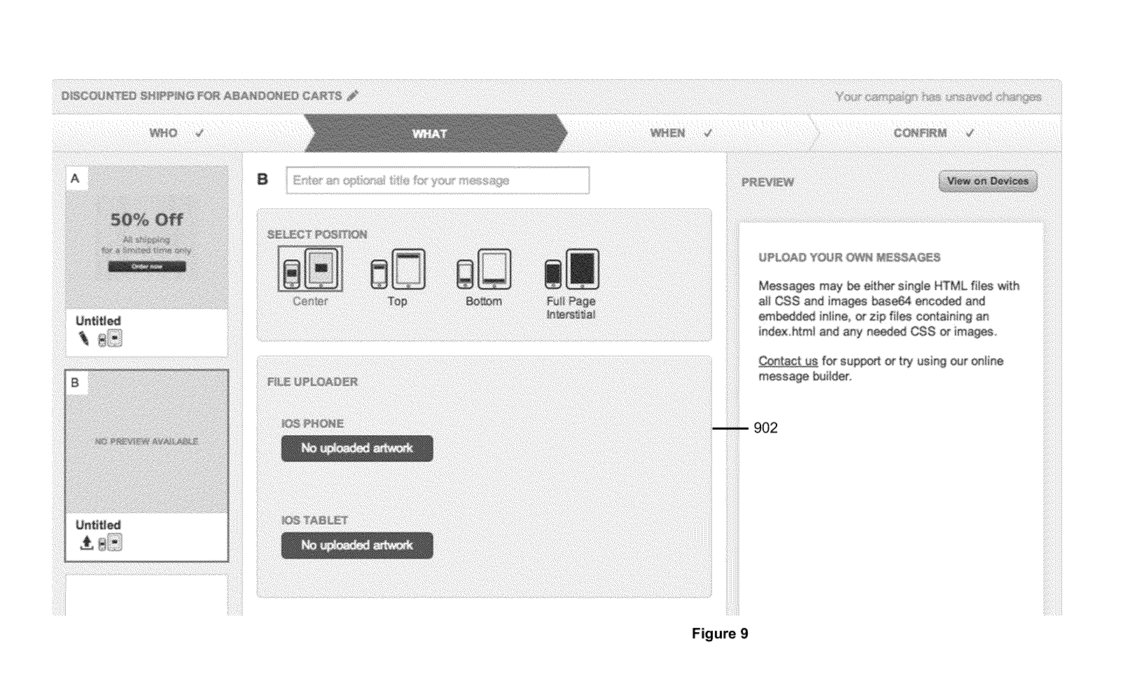

FIG. 9 illustrates the content upload feature 704 in more detail. In an embodiment, content upload feature 704 provides a window 902 for the user to upload content for various types of mobile devices, such an IOS phone or an IOS tablet.

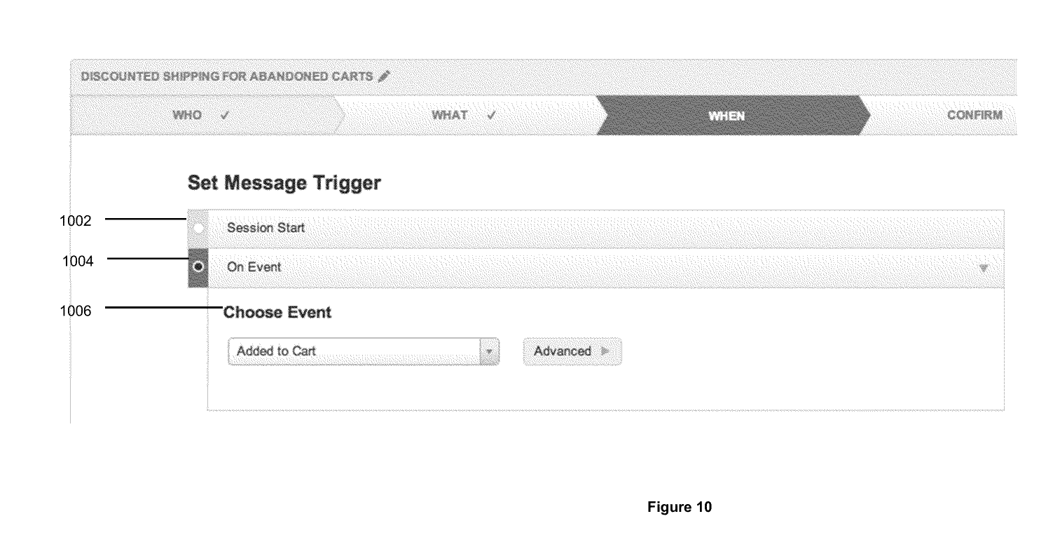

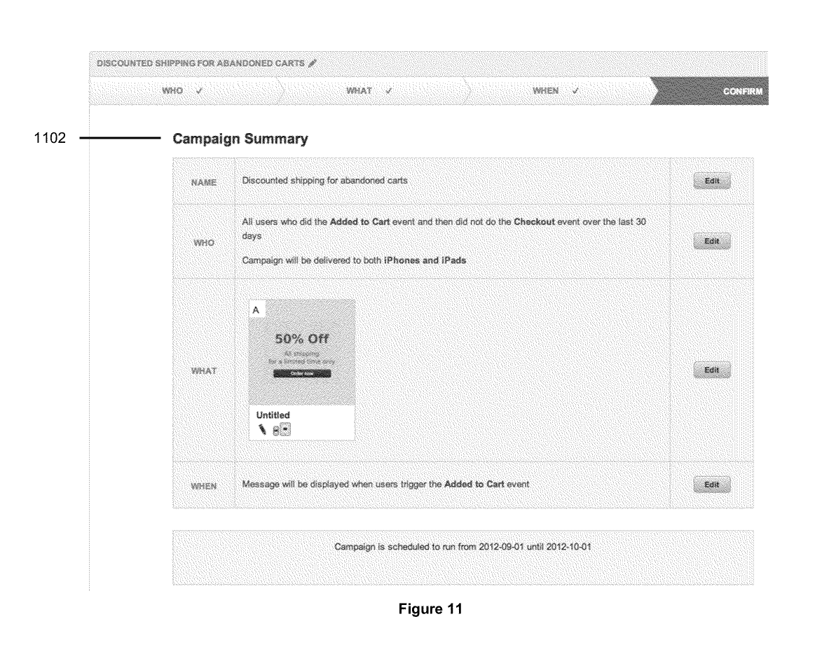

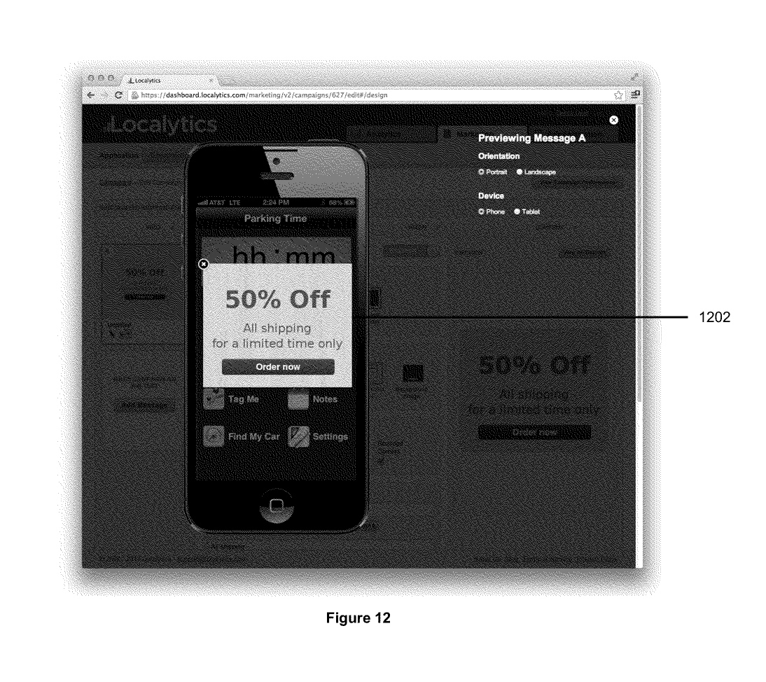

Once a target audience is confirmed and the in-app message is created, the client can then choose when the in-app message should be delivered. Referring to FIG. 10, a client can choose to trigger a message once the session for the application starts 1002 or upon the occurrence of a specific event 1004. If the client chooses specific event 1004, the client is given various choices of triggering events 1006. Along with determining when to display a message, a client may also choose to add an additional message. For example, a client could create A/B tests which cause different messages to be delivered to different users in the population based on certain characteristics. In this example, the client would generate another message in A/B test window 706, as well as applicable rules for delivery of the messages. Referring to FIGS. 11-12, a client can then review summary 1102 of the newly generated campaign, as well as, preview 1202 of how the campaign will look on a mobile device.

Once the in-app message is created, it is stored in analytics database 104 and then downloaded onto SDK 102 along with the appropriate rules for displaying the message. In another embodiment, SDK 102 obtains the message by receiving a separate uniform resource identifier (URI) for the message from rules engine 106. SDK 102 can use this URI to fetch the message in the background so it can continue to perform other tasks. While in-app messages are described, the present invention is not limited to creation or selection of messages only. A person of ordinary skill in the art would recognize that the present invention supports the creation or selection of a creative, which can include messages, images, graphics, banners, radio buttons, surveys, audio clips, and video clips.

In another embodiment, client actions 302 can also include in-app redirection 306. For this feature, device policy engine 202 tags all screens within an application so that the client can specify which screens should be used for redirection. Once screens are linked to triggering events, device policy engine 202 can drive the application to switch to the specified screen at the occurrence of a triggering event. This feature allows clients to direct end-users to other areas of the application without pushing an update to change the application's behavior. In one embodiment, in-app redirection 306 can be combined with in-app messaging 304. For example, an e-commerce application can utilize data stored in analytics database 104 to determine all users who have added items to a shopping cart in the last week but have not checked out. Rules engine 106 can then utilize this data to target these users, send them an in-app message to remind them to check out, possibly with an incentive to check out such as a discount or rebate, and then redirect the user to the checkout screen. In-app redirection 306 can also be used in various other scenarios, such as guiding users through in-app registrations, showcasing new features in an application, or guiding users around bugs or problems in the application. A person of ordinary skill in the art would understand that this feature could also be implemented by tagging a subset of all of the application's screens and then selecting the appropriate triggering event for all or each of the screens in the subset.

In another embodiment, client actions 302 can also include application configuration change 308. Unlike the previous client actions 302, application configuration changes 308 are not immediately visible to end-user. Instead, this feature allows for modifying application data, such as configuration files or data relationships stored in a database, such as the analytics database 104. Application configuration change 308 can be implemented into various mechanisms in analytics platform 100, such as: executing structured query language (SQL) code against stored databases; creating and performing search and replace operations on local files; and replacing stored defaults. These mechanisms allow a client to target a specific group of users and change the application settings in a particular manner.

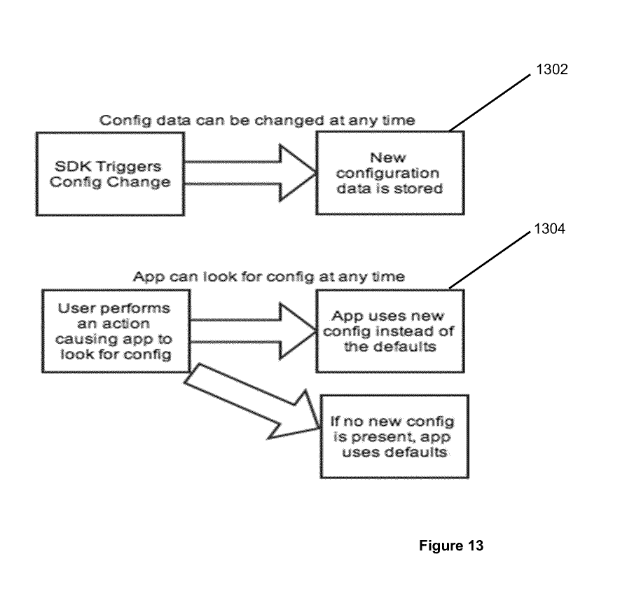

As shown in FIG. 13, configuration data can be changed based on scenarios 1302 and 1304. In scenario 1302, SDK 102 can trigger application configuration change 308 in response to instructions from rules engine 106. In scenario 1304, SDK 102 can trigger application configuration change 308 to move to a new configuration or a default configuration based on the occurrence of a particular trigger event. Exemplary application modifications include: slowly rolling out new features by enabling them for small portions of a user base, and then slowly extending the new features to broader portions of the user base if the feature seems to be successful; silently helping users get through difficult parts of a game by targeting users who are having trouble with the game and changing the difficulty of the game; and increasing the number of advertisements or creatives to users who are strongly engaged with the application.

In yet another embodiment of the present invention, client actions 302 can include application modification 310. This feature enables more complex changes than application configuration 308 by delivering executable code to a client device so that it can be run within the application's context. The executable code allows an application to modify its own behavior, similar to an application update. However, unlike an application update, which has to go through the app store and forces all users to download a new version of the application, these modifications 310 are shipped directly to end-user's device 114 from rules engine 106. This allows for modifications 310 to be executed on end-user's device 114 so that the user can receive updates without having to download a new version of the application. For example, if the analytics data has targeted a small subset of users as having an error in their applications, modification 210 allows for rules engine 106 to send a bug fix for that error to the device policy engine 202 for the targeted subset of users in order to update the application and fix the bugs.

In yet another embodiment of the disclosure, client actions 302 can include integrated actions, which might be generated outside of the application. Specifically, while in-app messaging 304, in-app redirection 306, configuration changes 308, and app modifications 310 can all occur within the application, integrated actions can be delivered through other channels, such as e-mail, push messages, and operating system notifications. If these integrated actions cause an end-user to open the application, the catalyst integrated action (e.g., e-mail, push message, operating system notification) can be recorded as being successful and made available for campaign analysis.

While the client can specify trigger events and their corresponding client actions 302 to be performed, the client can also specify the manner in which the client action 302 is delivered to the end-user's device 114. In an embodiment of the disclosure, the device policy engine 202 provides a client with various options for delivering a client event. Examples of delivery methods include real-time delivery, triggered delivery, and broadcast delivery. Real-time delivery provides targeted client actions 302 based on a user's usage pattern of the current session of the application. Triggered delivery provides targeted client actions 302 based on a user's overall usage pattern of the application. Lastly, broadcast delivery provides targeted client actions 302 to more than one user at the same time.

While SDK 102 can obtain analytics data based on a user's interactions with an application, and subsequently perform client actions 302, as needed, its functionality can be further augmented with additional analytics data and campaign data from databases on server-side 110.

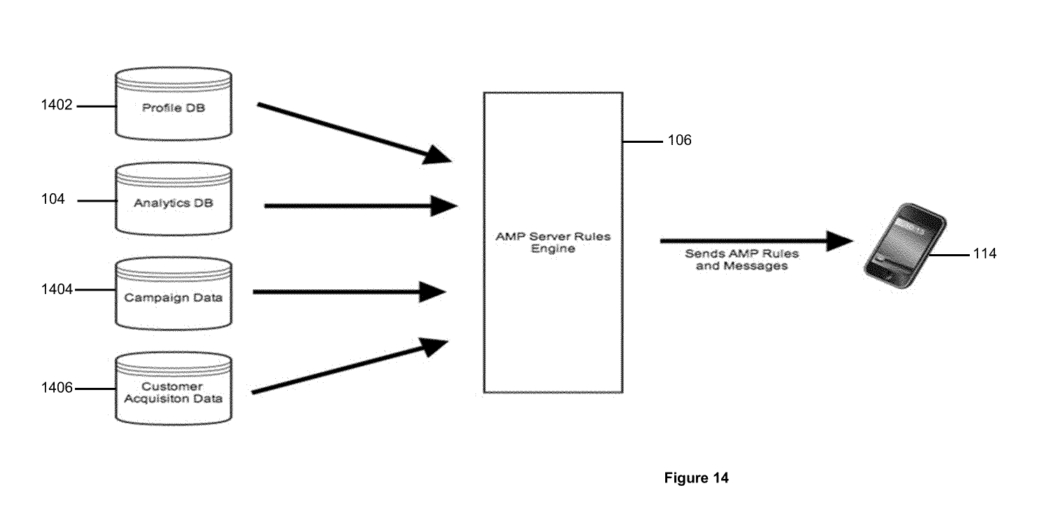

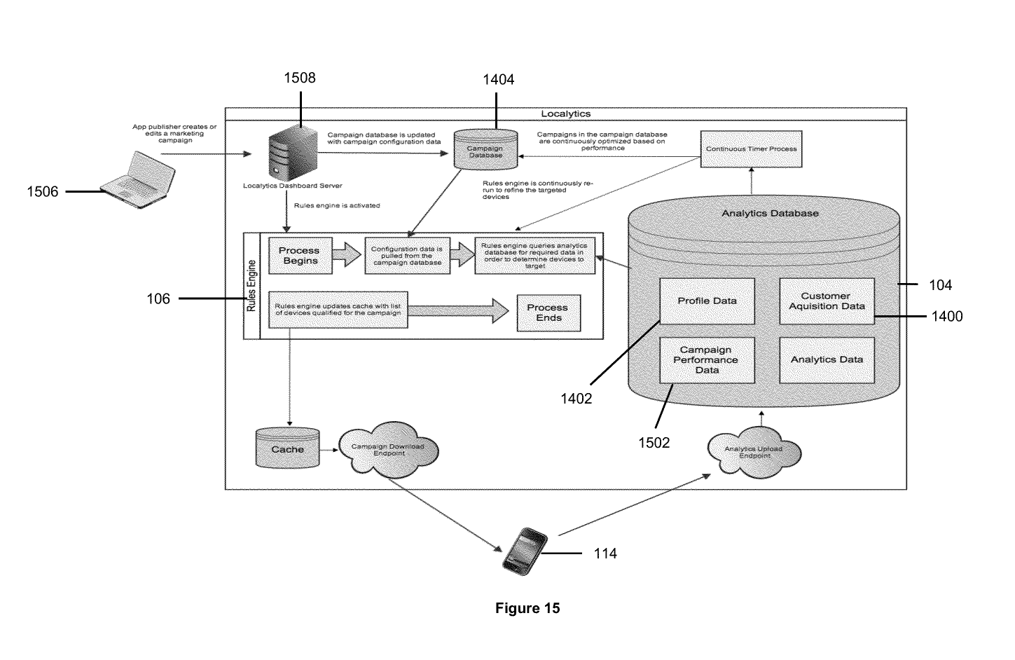

Referring to FIGS. 14-15, the databases on server-side 110 can include analytics database 104, user profile database 1402, campaign database 1404, and customer acquisition database 1406. Analytics database 104 can include any analytics data uploaded to server-side 110 from SDK 102. User profile database 1402 can include user-profile data on every end-user, or can include user-profile data on a specified subset of end-users. The user profiles could be based on exemplary factors such as aggregate usage data, user demographic data, and non-application data. Aggregate usage data can include factors such as: device type, operating system, mobile carrier, application release version, how often the end-user interacts with the application, when and how long the end-user remains in the application, geographic location of the end-user when the application is accessed, and the type of content the end-user accesses when running the application. User demographic data can include information such as gender, age, e-mail address, phone number, and application preferences. Non-application data can include information such as demographic or usage data from third parties.

In another embodiment of the present invention, user profiles may also include a calculation of Customer Lifetime Value (CLV) for a particular user. Various data can contribute to a positive CLV, such as repeat usage, advertisement engagement, and in-app purchases and subscriptions. The CLV contributes a good deal to the application analytics and performance information provided by analytics platform 100 because it allows clients to build, optimize, and prioritize their application marketing campaigns around this information. In one embodiment, the information for a user profile can be initially derived from analytics database 104 and then subsequently augmented with data about the end-user's interaction with an application.

Campaign database 1404 can include various client-generated creatives and campaigns along with their corresponding rules and targeted audiences. Campaign database 1404 can also include various data on campaign performance, campaign success, and user-interactions with campaigns.

Customer acquisition database 1406 can include data on users who were acquired through specific advertising campaigns, such as through Google, Facebook, etc.

In one embodiment, all four databases can be separate, as shown in FIG. 14. In another embodiment, user profile database 1402, campaign database 1404, and customer acquisition database 1406 can be included within analytics database 104.

A person of ordinary skill of the art would recognize that analytics platform 100 can be easily modified such that these databases can all be physically separate, consolidated into analytics database 104, or some combination of both.

As shown in FIG. 14, these databases can provide various analytics data to rules engine 106 to ensure that it can craft the most current rules and client actions 302 for various campaigns. In one embodiment, rules engine 106 can also include targeting logic to determine which end-users should be targeted for a particular campaign based on analytics data obtained by querying at least analytics database 104, user-profile database 1042, campaign database 1404, and customer acquisition database 1406. In another embodiment of the disclosure, rules engine 106 can also include a client delivery service component that is responsible for the actual delivery of client actions 302 and corresponding rules to the appropriate end users.

FIG. 15 illustrates the interactions of server-side 110 when a new campaign is created by a client in an embodiment of the disclosure. When a client has created a new campaign on campaign interface 1506, the campaign is transmitted via server 1508 to campaign database 1404, where the specifics of the campaign (creative, corresponding rules, target audience, etc.) are stored. Campaign database 1404 can then continuously query analytics database 104 for updated profile data 1402, customer acquisition data 1406, aggregated campaign performance data 1502, and any other type of analytics data in order to continuously optimize the performance of the newly created campaign. Rules engine 106 can then draw on all of this data, along with its own campaign optimization software, to determine if it needs to provide any updates to the manifest of client actions 302 and corresponding rules, or updates to the targeted audience, for that particular campaign. If there are updates, rules engine 106 can transmit them to end-user's device 114.

In order to begin using analytics platform 100, the client can first integrate SDK 102 into the application during construction of the application. In another embodiment, a client can first install a base analytics program that has a subset of features into the application during construction of the application, and then install the full functionality of analytics platform 100 by integrating a client library. The client library can be a drop-in replacement for the base analytics program that was originally integrated, and does not require additional integration work. Clients who integrate the client library can immediately receive access to all of the features of analytics platform 100. In one embodiment, the drop-in client library can include software responsible for: receiving data from the server-side 110; storing data locally on user's device 114 and avoiding duplicated data; providing performance tracking for client actions 302 and measuring the values for CLV analysis; and utilizing device policy engine 202 to evaluate and execute client actions 302. While updating the client software can require an update to the application, user's device 114 can be dynamically configurable to disable or change behavior to avoid trouble with obsolete versions of the client library.

Once analytics platform 100 is incorporated into the application, a client can then build and implement a campaign for the application. The campaign-building process can include such steps as: naming the campaign; identifying the target audience; determining client action 302; determining when to perform client action 302; determining a conversion event; and determining a schedule for the campaign.

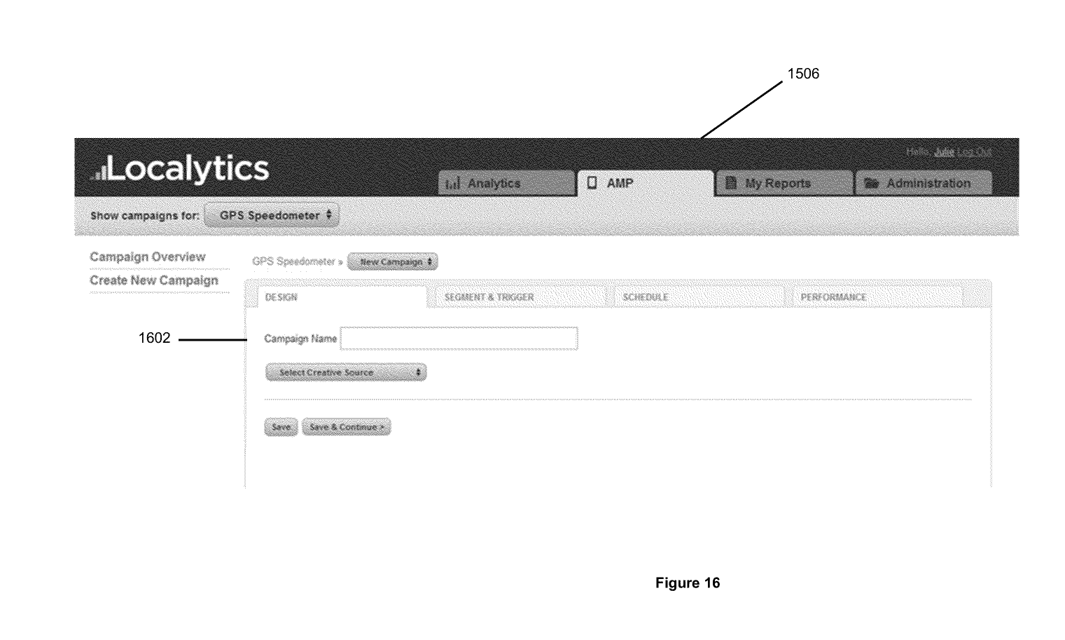

FIGS. 16-18 show exemplary illustrations of the interface by which a client can begin and build and implement a campaign. Campaign interface 1506 allows a client to start building a campaign by providing campaign name 1602. Naming the campaign allows the client to easily identify and keep track of each campaign. This is particularly helpful if a client creates several campaigns, and wants to compare analytics and success rate for each campaign in different situations.

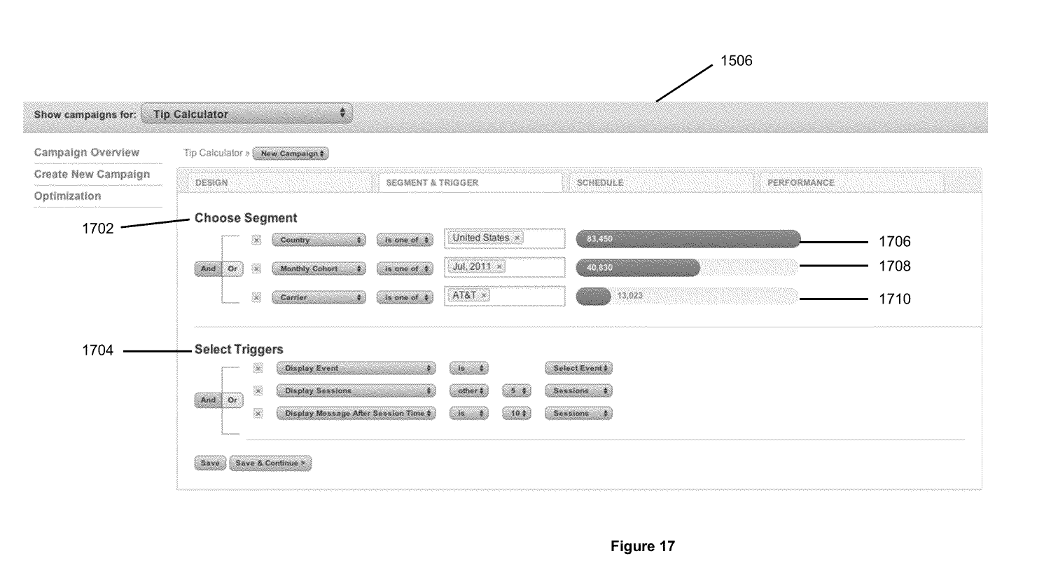

Referring to FIG. 17, a client can then specify the targeted audience by choosing a combination of segments 1702 and triggers 1704. Segments 1702 describe profile attributes, such as location, device, or carrier. Triggers 1704 describe behavioral attributes, such as users who have viewed four articles in a single session, or users who have logged five sessions in one week. As shown in FIG. 17, as segments are entered to narrow the target audience, campaign interface 1506 shows how many users are eligible 1706, 1708, 1710 as each segment is entered. A client may utilize one or more segments 1702 and/or one or more triggers 1704 in order to target a group of users for a campaign.

In order to determine a proper client action 302 for a campaign, a client can choose from a number of client actions 302 that have been stored in the device policy engine 202. In one embodiment, an initial set of client actions 302 is stored on the device policy engine 202 when SDK 102 is incorporated into the application, and additional client actions 302 can be downloaded from rules engine 106. In another embodiment, the client can create a new client action, such as an in-app message, as illustrated in FIGS. 5-12.

A client can also determine a conversion event for a campaign. A conversion event is a specific event, such as purchasing an item, that is monitored by analytics database 104 and/or campaign database 1404. If this specific event has occurred, the end-user has said to have “converted” the event, meaning that the user has successfully completed the intended action. Conversion events are a key performance indicator in campaign analytics to determine how well a campaign is doing.

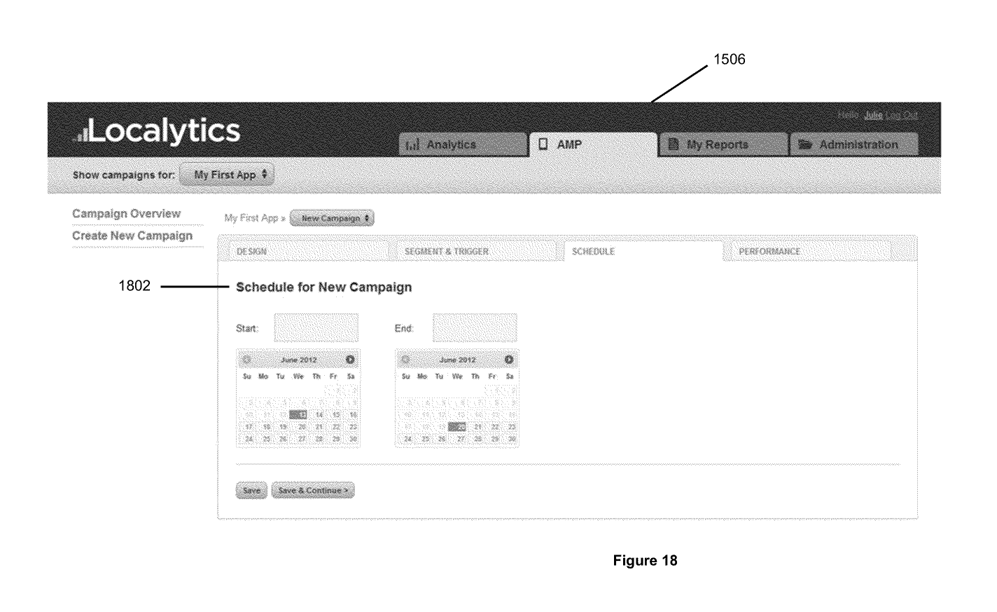

Lastly, a client may specify a schedule for the campaign. As shown in FIG. 18, campaign interface 1506 allows a client to set schedule 1802 for every new campaign, which can include set start times and/or dates for the campaign. In another embodiment, a client can choose to manually start or end a campaign ahead of or after the scheduled date and/or time. In another embodiment, the client can choose not to specify a start date and/or time, or an end date and/or time, but rather can control the entire schedule manually.

Once a client has built a campaign, determined the proper users to direct the campaign to, and specified a start and end time (if any) for the campaign, the client can then test the campaign before broadly pushing the campaign to a larger audience. For clients, testing marketing campaigns can be challenging. The client usually has to involve a developer to create a one-off build of the application so that it is configured to receive test content, and then distribute that one-off build of the application to devices through complicated testing channels instead of the widely available app stores (e.g., Apple App Store, Google Play). This process is complicated, can cause delays, waste resources, and incur significant expenses. In an embodiment of the disclosure, the test mode can test any version of an application containing client software, including a version of the application that is publicly distributed through the platform's application store. For example, if a client wanted to test a new campaign in an existing New York Times application from a platform's application store, and the application did not have the client software of the present disclosure, then the client would have to design a one-off New York Times application and download it to the client's device in order to test the new features. However, with the test mode in the present disclosure, a client can simply design and test a campaign on numerous specified devices within the existing New York Times application that had been downloaded from the platform's application store.

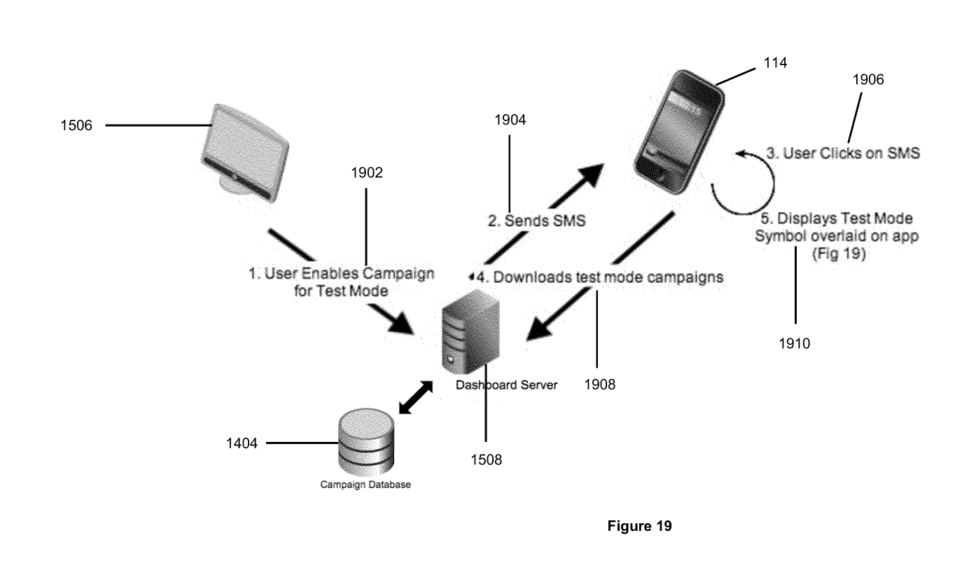

In one embodiment, the test mode feature allows clients to interactively preview client software behavior associated with a given campaign on a controlled set of devices before broadly releasing the campaign to a full audience. FIG. 19 shows a schematic diagram of the test mode feature in one embodiment of the present invention. After a client has created a new campaign or revised an existing campaign on campaign interface 1506, the client can enable test mode for the campaign in step 1902. When test mode is enabled, server 1508 flags the campaign in campaign database 1404 as having activated test mode. In step 1904, server 1508 then provides the client with a specifically formatted uniform resource identifier (URI), or an “Activation URI”, and directs the client to click on the activation URI from any device that the client wishes to use. Server 1508 can then provide features such as SMS and email dispatch facilities to aid the client with delivering the activation URI to selected users and devices 114.

When a recipient clicks on the activation URI in step 1906, the operating system will invoke the client software to handle further processing of the activation URI based on the previous registration of the protocol scheme. Upon the first run of the client software inside the client's application, the client software can tell the device's operating system that all URIs conforming to the protocol scheme used by the activation URI should be processed by the client software upon being clicked. The protocol scheme is unique to the client's application and can be derived by either the client software or the server software based on the application's identifier. No communication between the client software and server software is required in order for them each to have independent knowledge of the protocol scheme.

In one embodiment, the activation URI contains encoded within it special directives that will be interpreted by the client software and device policy engine 202, In step 1908, the client software will receive directives that cause the client software to download all available test campaign information from the server software. The client may then navigate through the application and be able to perform particular client actions 302 for relevant test campaigns based on the occurrence of specified trigger events. In another embodiment, the activation URI will direct the client software to perform the client action 302 associated with a given campaign.

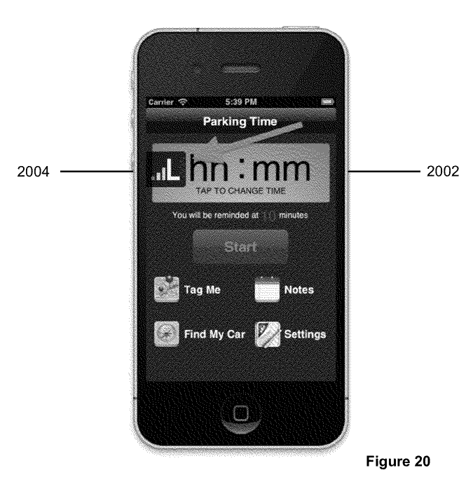

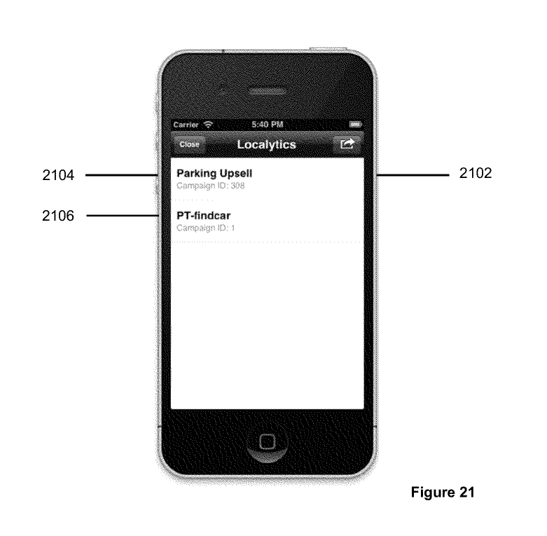

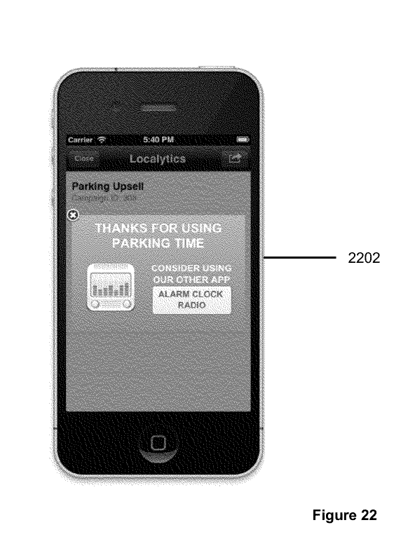

In step 1910, the activation of test mode on the client software can cause a test icon 2004 to appear overlaid on top of the application's content 2002 (FIG. 20). As shown in FIGS. 20-22, the client may click on icon 2004 to access in-app control panel 2102, which allows the client to view information about campaigns 2104, 2106 and invoke the client actions 302 of specific campaigns on demand 2202, bypassing the need to have the specified trigger events occur first. From this control panel 2102, the client may also modify the behavior of the campaign. Any changes that the client makes from control panel 2102 can be propagated back to the server software and saved with the campaign in campaign database 1404.

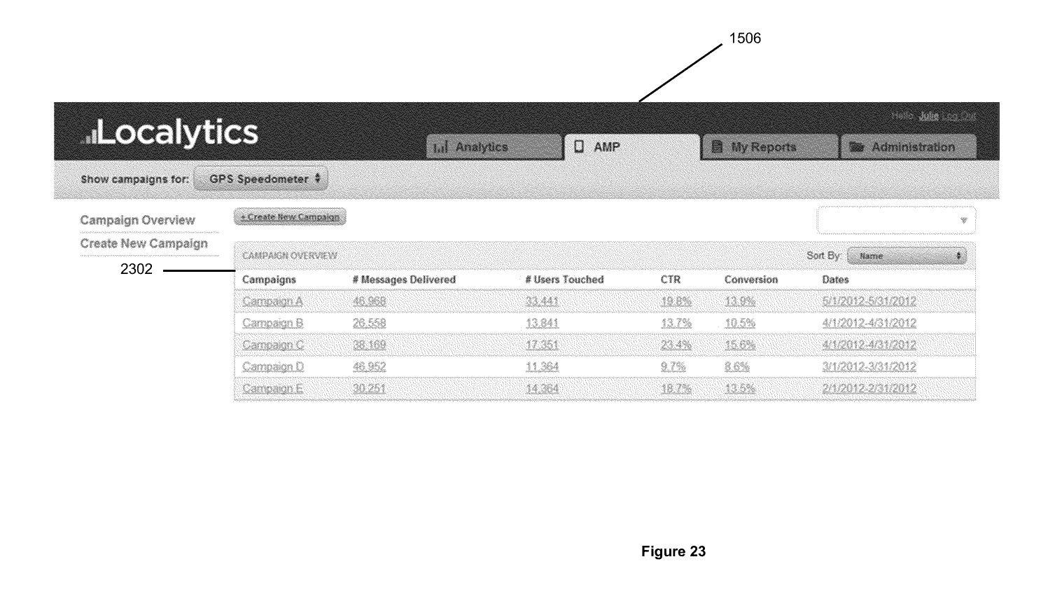

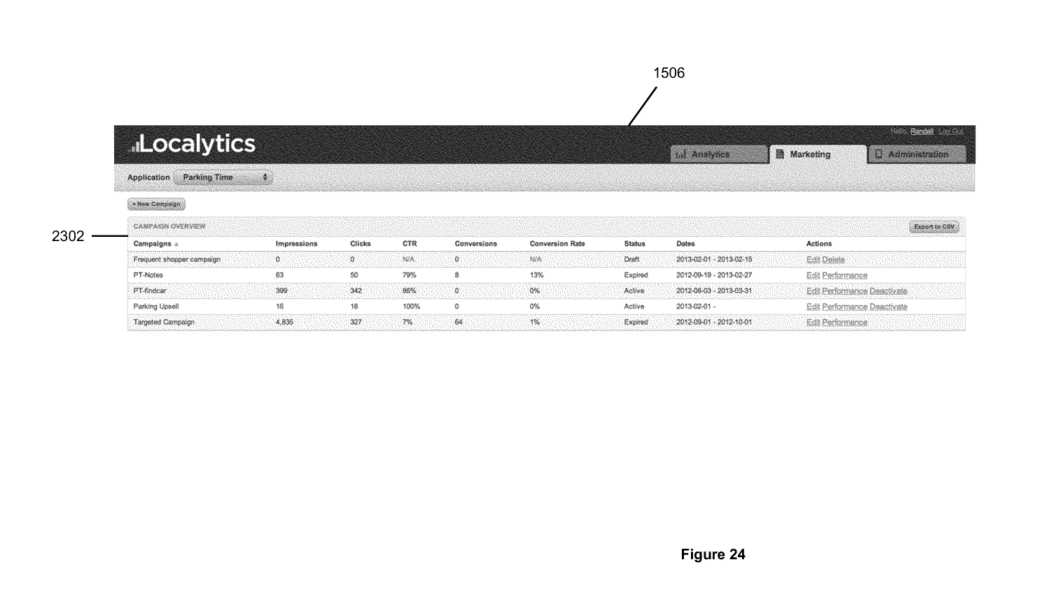

In one embodiment, campaign interface 1506 also provides summary, performance, and analytics data on various campaigns. As shown in FIGS. 23-24, campaign interface 1506 can provide different versions of overview screen 2302 to summarize all of a client's campaigns, or a subset of a client's campaigns.

This feature can provides a snapshot of all selected campaigns listed by a particular characteristic, such as chronological order. In one embodiment, the snapshot can also provide a few columns of additional campaign data, such as performance data or schedule data. From overview screen 2302, a client can click into any specific campaign to view/edit tabs like schedule and performance. Within the performance tab, a client can see how an individual campaign has impacted key metrics like CLV and total purchases. The client can also see how many users were eligible for a campaign, along with data such as number of impressions (message views), clicks, and conversions for that campaign.

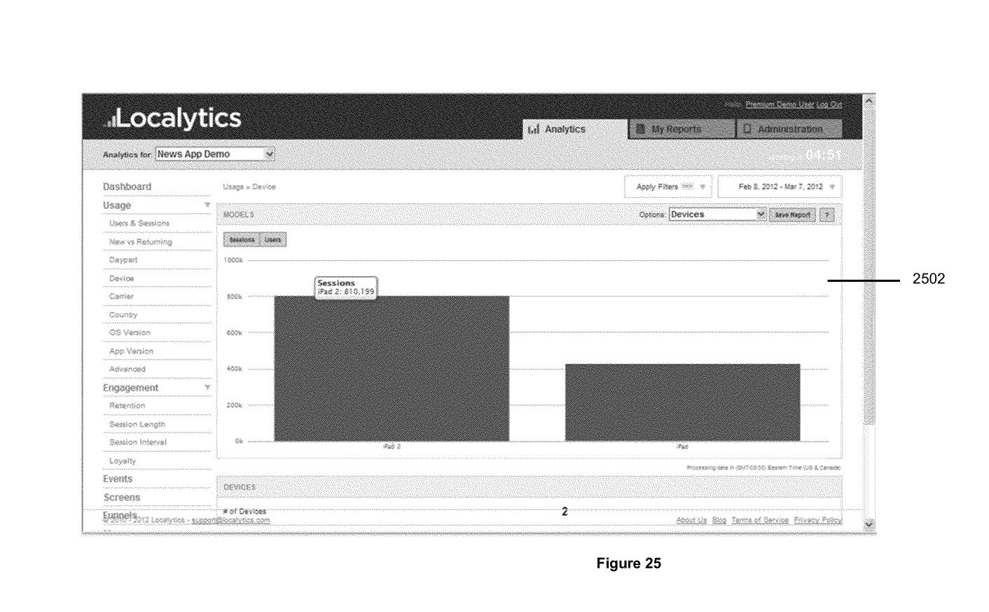

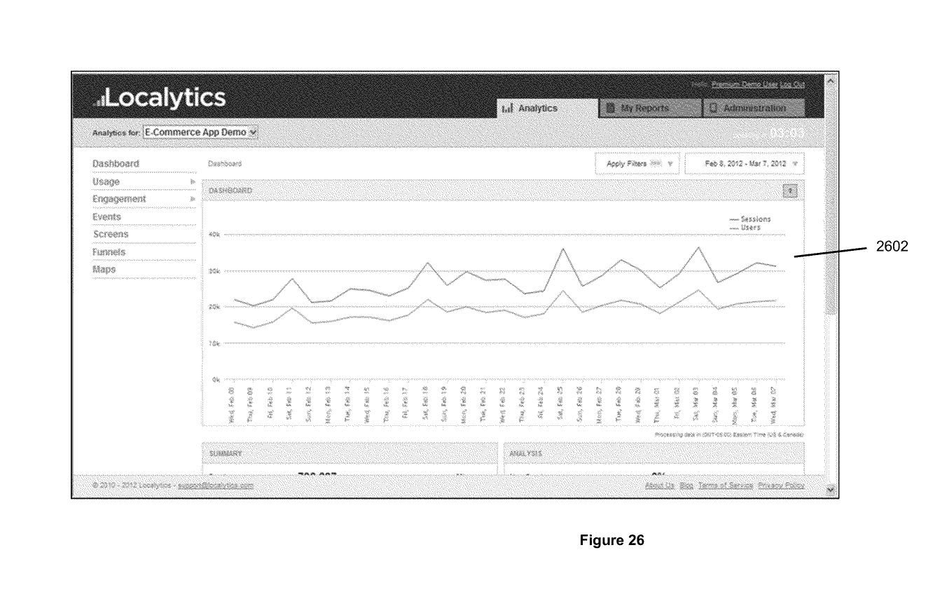

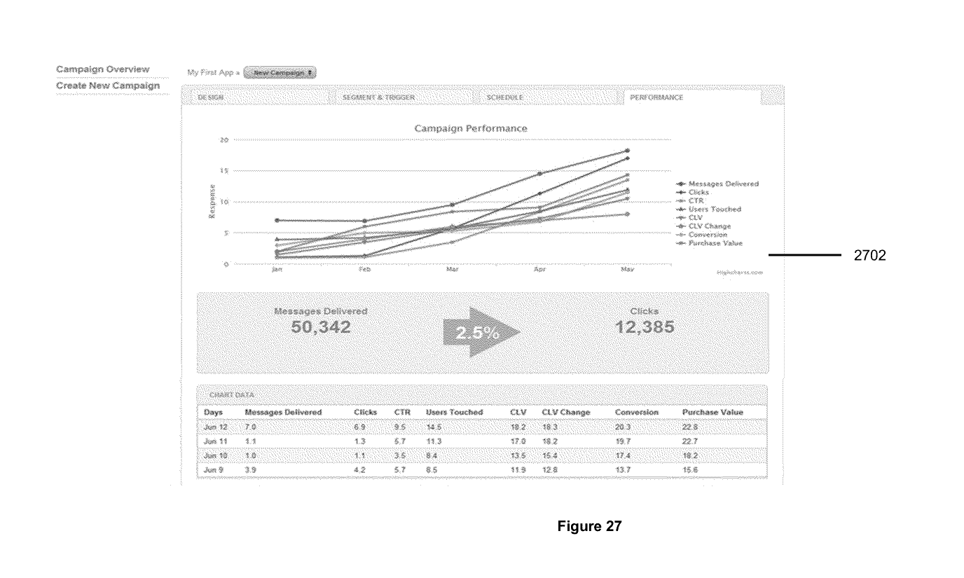

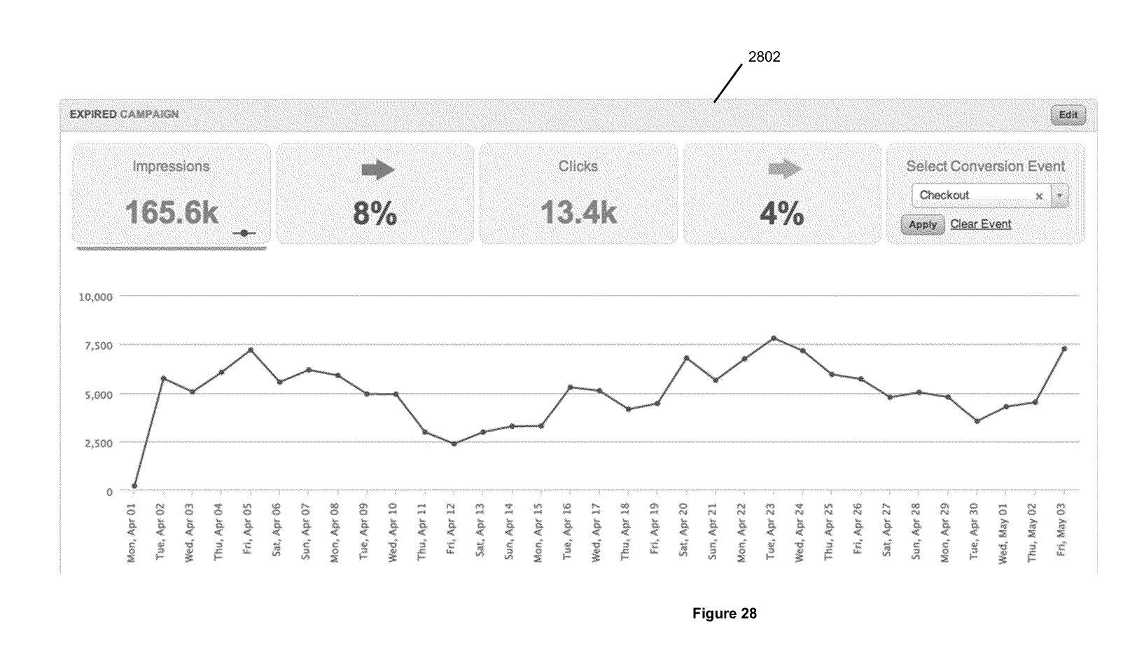

FIGS. 25-28 illustrate various types of analytics data 2502, 2602, 2702, and 2802, that campaign interface 1506 can provide to a user. Campaign interface 1506 can also be configured to allow clients to compare campaigns to each other and/or compare how different creatives within a campaign perform.

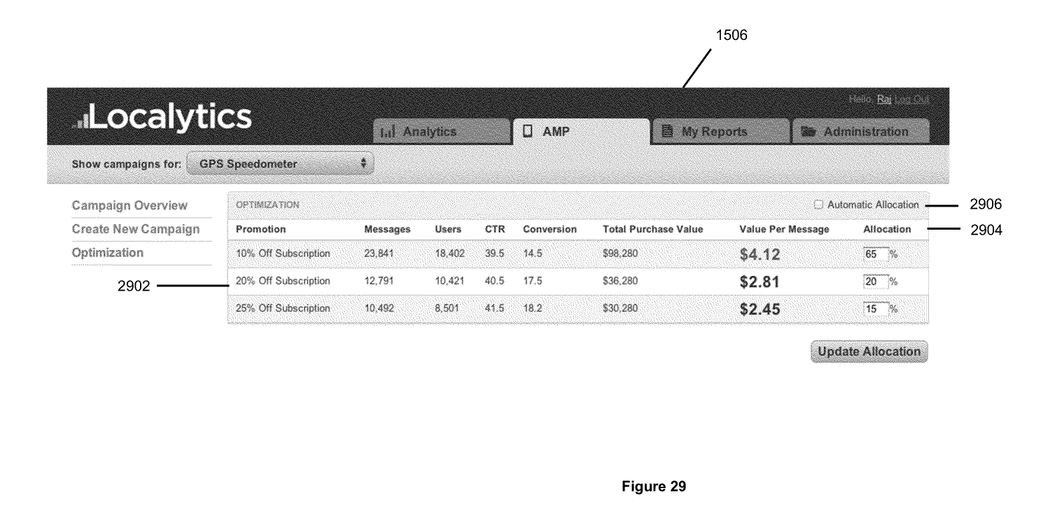

In another embodiment of the disclosure, campaign interface 1506 can also include campaign optimization 2902, as shown in FIG. 29. Campaign optimization 2902 recognizes that server-side 110 has access to performance analytics of current and previous campaigns through analytics database 104 and its associated databases, which allows analytics data to be mixed with campaign data to provide optimizations for running the campaign. For example, if the gathered analytics data shows that a specific creative is more successful than another, or a certain segment is less responsive than another segment, campaign optimization 2902 will allow the client to adjust the targeting rules and selection of creatives in the campaign in order to optimize the campaigns. In another example, campaign optimization may allow the client to adjust allocation of resources 2904 for each of the campaigns based on the analytics data.

As shown in FIG. 29, a user has adjusted the allocation of resources 2904 for the first campaign because it has the highest value per message. In yet another embodiment, a client can utilize automated campaign optimization software stored in rules engine 106 to continuously monitor and leverage existing analytics data to automatically provide optimizations for a particular campaign in real-time without user intervention. In order to utilize the automatic campaign optimization feature in FIG. 29, a client can select automatic allocation 2906, which automatically changes the allocation for each message to optimize the campaign without any user intervention.

In yet another embodiment of the present invention, two identical campaigns can be created with different creatives so that the automated campaign optimization feature can select the creative that yields a higher average CLV. This embodiment can also be applied to other scenarios, such as where there are multiple paths to send the user. This occurs when navigation-oriented client actions 302 cause the application to switch to different screens. The embodiment can also apply to any other client action 302 where it is possible to measure an impact on CLV.

While the description of campaign building, monitoring, and optimization is described in relation to a client, one of ordinary skill would understand that it could also be described in relation to a third party marketer. A client could simply construct an application with analytics platform 100 incorporated into it, while a third party marketer could be responsible for developing marketing campaigns for analytics platform 100.

Although the above description describes an embodiment of the present invention, it should be understood that the techniques and concepts are applicable to other information platform and database systems in general. Thus the invention may be embodied in other specific forms without departing from the spirit or essential characteristics thereof. The embodiments disclosed in the figures are therefore to be considered in respects as illustrative and not restrictive.

While the above describes a particular order of operations performed by a given embodiment of the invention, it should be understood that such order is exemplary, as alternative embodiments may perform the operations in a different order, combine certain operations, overlap certain operations, or the like. References to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium including, without limitation, any type of disk including optical disks, CD-ROMs, and magnetic-optical disks, read-only memory (ROM), random access memory (RAM), magnetic or optical cards, or any type of media suitable for storing electronic instructions.

While given components of the system have been described separately, one of ordinary skill also will appreciate that some of the functions may be combined or shared in given instructions, program sequences, code portions, and the like.

What is claimed is:

1. A platform for performing application-level analytics and tailoring actions and communications to enhance a user's experience, the platform comprising:
a mobile device configured to run a mobile application, the mobile device further including a device policy engine configured to maintain a list of campaigns comprising a plurality of trigger events and a plurality of client actions, each of the plurality of trigger events corresponding to at least one of the plurality of client actions, the device policy engine being further configured to monitor a user's interactions with the mobile application, measure the user's interactions to determine whether at least one of a plurality of trigger events has occurred, perform at least one of a plurality of client actions corresponding to at least one of the plurality of trigger events, and record data relating to the user's interactions with the campaign;
an analytics database configured to receive the recorded data from the mobile device, the analytics database also configured to receive information on new or modified campaigns, the information including at least one of: a creative, at least one rule for identifying a targeted audience, at least one trigger event, and at least one client action, the analytics database utilizing the recorded data and the information on new or modified campaigns to maintain a set of analytics data on users and campaign performance;
a rules engine configured to receive a plurality of parameters governing at least one campaign and at least a subset of the analytics data maintained in the analytics database to create a set of rules for the at least one campaign relating to at least one of: a target audience, at least one client action, and at least one trigger event, the rules engine configured to transmit the set of rules to the mobile device;
a campaign optimization module configured to receive data from the analytics database in order to make changes to at least one campaign to increase the performance of the at least one campaign, the campaign optimization module further configured to generate a set of optimization rules for modifying the at least one campaign and sending the set of optimization rules to the rules engine; and
a test module configured to receive the information on the new or modified campaign and generate a test campaign, the test module further configured to transmit the test campaign to a plurality of test users specified by a client, the test module further configured to provide a test panel to the client in order to change the new or modified campaign or manually trigger at least one of a plurality of client actions associated with the new or modified campaign.

2. The platform of claim 1, wherein the plurality of client actions include at least one of: in-app messaging, in-app redirection, application configuration change, and application modification.

3. The platform of claim 1, wherein the in-app messaging is configured to generate a message that can provide analytics data to the analytics database based on the user's interaction with the message.

4. The platform of claim 1 further comprising a user-interface configured to allow the client to build a new message.

5. The platform of claim 4, wherein the client can specify at least one of a plurality of characteristics when building the message, the plurality of characteristics including: a targeted audience, a targeted device, a plurality of message characteristics, and a trigger for initiating the message.

6. The platform of claim 1, wherein the rules engine is configured to continuously query the analytics database for data that could change the set of rules for the at least one campaign.

7. The platform of claim 6, wherein the rules engine is configured to detect a change in rules for the at least one campaign, generate an updated set of rules for the at least one campaign, and transmit the updated set of rules to the device policy engine.

8. The platform of claim 1, further comprising a campaign-interface to allow the client to build a new campaign.

9. The platform of claim 8, wherein the campaign-interface is configured to continuously query the analytics database for data in order to provide the client with real-time analytics for the new campaign.

10. The platform of claim 1 wherein the campaign optimization module is configured to allow the client to modify at least one of the optimization rules for the at least one campaign to increase the at least one campaign's performance.

11. The platform of claim 1, wherein the campaign optimization module is configured to automatically make changes to at least one of the optimization rules for the at least one campaign to increase the at least one campaign's performance.

12. The platform of claim 1, wherein the test module is configured to allow the test users to use the test campaign in existing versions of the mobile application.

13. The platform of claim 1, wherein device policy engine is configured to continue operation regardless of whether the mobile device has a network connection to the analytics database and the rules engine.

14. A method for performing application-level analytics and tailoring actions and communications to enhance a user's experience, the method comprising:
configuring a mobile device to run a mobile application;
configuring a device policy engine integrated into the mobile device to maintain a list of campaigns comprising a plurality of trigger events and a plurality of client actions, each of the plurality of trigger events corresponding to at least one of the plurality of client actions, the device policy engine also monitoring a user's interactions with the mobile application, measuring the user's interactions to determine whether at least one of a plurality of trigger events has occurred, performing at least one of a plurality of client actions corresponding to at least one of the plurality of trigger events, and recording data relating to the user's interactions with the campaign;
configuring an analytics database to receive the recorded data from the mobile device, the analytics database also receiving information on new or modified campaigns, the information including at least one of: a creative, at least one rule for identifying a targeted audience, at least one trigger event, and at least one client action, the analytics database utilizing the recorded data and the information on new or modified campaigns to maintain a set of analytics data on users and campaign performance;
configuring a rules engine to receive a plurality of parameters governing at least one campaign and at least a subset of the analytics data maintained in the analytics database to create a set of rules for the at least one campaign relating to at least one of: a target audience, at least one client action, and at least one trigger event, the rules engine configured to transmit the set of rules to the mobile device;
configuring a campaign optimization module to receive data from the analytics database in order to make changes to at least one campaign to increase the performance of the at least one campaign, the campaign optimization module generating a set of optimization rules for modifying the at least one campaign and sending the set of optimization rules to the rules engine; and
configuring a test module to receive the information on the new or modified campaign and generate a test campaign, the test module transmitting the test campaign to a plurality of test users specified by a client, the test module further providing a test panel to the client in order to change the new or modified campaign or manually trigger at least one of a plurality of client actions associated with the new or modified campaign.

15. The method of claim 14, wherein the plurality of client actions include at least one of: in-app messaging, in-app redirection, application configuration change, and application modification.

16. The method of claim 14, wherein the rules engine continuously queries the analytics database for data that could change the set of rules for the at least one campaign.

17. The method of claim 16, wherein the rules engine detects a change in rules for the at least one campaign, generates an updated set of rules for the at least one campaign, and transmits the updated set of rules to the device policy engine.

18. The method of claim 14, wherein the campaign optimization module automatically makes changes to at least one of the optimization rules for the at least one campaign to increase the at least one campaign's performance.

19. The method of claim 14, wherein test users can use the test campaign in existing versions of the mobile application.

20. The method of claim 14 wherein the device policy engine continues to operate regardless of whether the mobile device has a network connection to the analytics database and the rules engine.
